(19) United States
(12) Patent Application Publication
(10) Pub. No.: US 2026/0033646 A1
(43) Pub. Date: Feb. 5, 2026

(54) SEAT ASSEMBLY AND CLIP

(71) Applicant: Lear Corporation, Southfield, MI (US)

(72) Inventors: Christopher D. Johnson, Novi, MI (US); Thomas A. Welch, Ortonville, MI (US); Michelle A. Brudzynsky, Farmington Hills, MI (US); Thomas Welch, JR., Ortonville, MI (US); Bradley C. Duncan, Harrison Twp., MI (US); Mark Karges, Macomb, MI (US)

(73) Assignee: Lear Corporation, Southfield, MI (US)

(21) Appl. No.: 18/791,941

(22) Filed: Aug. 1, 2024

(51) Int. Cl. A47C 31/02; B60R 13/02

(52) U.S. Cl. CPC A47C 31/023; B60R 13/0206

(57) ABSTRACT

A clip and a seat assembly comprising the clip. The clip is disposed in a mesh member. The mesh member comprises a set of filaments. The clip has a barb and a mount. The barb secures the clip to the mesh member. A hook and loop fastener secures a trim cover to the clip.

### TECHNICAL FIELD

Various embodiments relate to seat assembly and a clip that secures a trim cover to a seat assembly.

### BRIEF DESCRIPTION OF THE DRAWINGS

FIG. 1 is a perspective view of an example of a seat assembly.

FIG. 2 is a perspective view of an example of a cushion of the seat assembly.

FIG. 3 is schematic view of an example of a manufacturing system for making a mesh member for the cushion.

FIG. 4 is a perspective view of an example of a clip with a hook and loop fastener omitted from some clip segments for clarity.

FIG. 5 is an end view of the clip shown in FIG. 4 with the hook and loop fastener omitted for clarity.

FIG. 6 is a plan view of a portion of the clip shown in FIG. 5 with the hook and loop fastener omitted for clarity.

FIG. 7 is a side view of a portion of the clip shown in FIG. 5 with the hook and loop fastener omitted for clarity.

FIG. 8 is a flowchart of a method of manufacture and installation of the clip into the cushion.

FIG. 9 is a simplified side view of an example of the mesh member.

FIG. 10 is a simplified side view of the mesh member of FIG. 9 with a slit.

FIG. 11 is a side view of the mesh member with the clip of FIG. 4, the clip being shown as an end view without the hook and loop fastener.

FIG. 12 is a simplified side view of the mesh member with a trim cover secured to the clip.

FIG. 13 is a side view of the mesh member with the clip, the clip being shown as a side view.

FIG. 14 is a plan view of an example a portion of the mesh member with the clip.

FIG. 15 is a simplified side view of the mesh member illustrating the clip positioned at different elevations in the mesh member and illustrating examples of hook and loop fasteners that extend to multiple clip segments and that do not extend to multiple clip segments.

FIG. 16 is an end view of a second configuration of a clip.

FIG. 17 is an end view of a third configuration of a clip.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It is to be understood that the disclosed embodiments are merely exemplary and that various and alternative forms are possible. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ embodiments according to the disclosure.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a” and “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises.” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting.” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

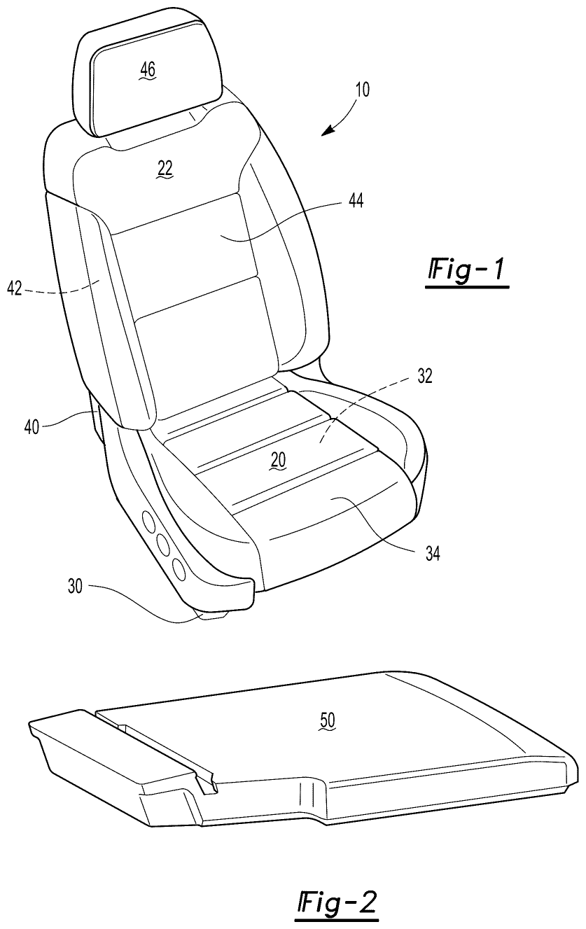

Referring to FIG. 1, an example of a seat assembly 10 is shown. In some embodiments, the seat assembly 10 is a vehicle seat assembly, such as for a land vehicle like a car, truck, bus, or the like, or for a non-land vehicle like aircraft or watercraft. For example, a seat assembly 10 for a land vehicle may be shaped and sized as a front row driver or passenger seat, a second, third, or other rear row seat, and may include bench-style seats, bucket seats, or other seat styles. Furthermore, the seat assembly 10 may be a non-stowable seat or a stowable seat that may be foldable or foldable and stowable in a cavity in the vehicle floor. Additionally, the seat assembly 10 may be configured for non-vehicle applications such as furniture.

In the configuration shown in FIG. 1, the seat assembly 10 includes a seat bottom 20 and a seat back 22. It is contemplated that the seat back 22 may be omitted in some configurations, such as when the seat assembly 10 is configured as a motorcycle seat or stool.

The seat bottom 20 is configured to receive a seated occupant and support the pelvis and thighs of the seat occupant. The seat bottom 20 includes a seat bottom frame 30, a cushion 32, and a trim cover 34.

The seat bottom frame 30 is a structure that supports the cushion 32. The seat bottom frame 30 includes one or more structural members and may be made of any suitable material, such as a metal alloy, polymeric material, fiber reinforced polymeric material, or combinations thereof. In some configurations, the seat bottom frame 30 includes a panel, seat pan, suspension mat, suspension wires, or the like upon which the cushion 32 is disposed.

The cushion 32 is disposed on the seat bottom frame 30. The cushion 32 is made of a compliant material that supports the seat occupant and distributes load forces from the seat occupant to the seat bottom frame 30. The cushion 32 and associated methods of manufacture will be discussed in more detail below.

The trim cover 34 covers at least a portion of the cushion 32. In addition, the trim cover 34 provides one or more visible exterior surfaces of the seat back 22. The seat occupant may be disposed on the trim cover 34 when seated upon the seat assembly 10. The trim cover 34 is made of any suitable material or materials, such as fabric, leather, leatherette, vinyl, or combinations thereof. The trim cover 34 may include one trim panel or a plurality of trim panels that are assembled in any suitable manner, such as by fusing or stitching. The trim cover 34 is attached to the seat bottom frame 30, the cushion 32, or both. For example, the trim cover 34 may include trim attachment features that are attached to the seat bottom frame 30, the cushion 32, or both, to inhibit removal of the trim cover 34 and help conform the trim cover 34 to the contour of the seat bottom frame 30, the cushion 32, or both. The trim cover 34 may also be attached to an attachment pad in some configurations. It is contemplated that different types of trim attachment features may be employed to attach the trim cover 34 to the seat bottom frame 30 than to the cushion 32.

The seat back 22 is configured to support the back of a seated occupant. The seat back 22 is disposed adjacent to the seat bottom 20. For example, the seat back 22 may be disposed above the seat bottom 20 and near the rear side of the seat bottom 20. The seat back 22 extends in a generally upward direction away from the seat bottom 20. In some configurations, the seat back 22 is mounted to the seat bottom 20 and may be pivotable with respect to the seat bottom 20. In other configurations, the seat back 22 is not mounted to the seat bottom 20. For instance, a vehicle seat back may be mounted to the vehicle body structure, such as in some second row seat assemblies. The seat back 22 includes a seat back frame 40, a cushion 42, a trim cover 44, and optionally a head restraint 46.

The seat back frame 40 is a structure that supports the cushion 42. The seat back frame 40 includes one or more structural members and may be made of any suitable material, such as a metal alloy, polymeric material, fiber reinforced polymeric material, or combinations thereof. In one or more configurations, the seat back frame 40 includes a panel, pan, suspension mat, or suspension wires upon which the cushion 42 is disposed. It is also contemplated that the seat back frame 40 may be integrally formed with the seat bottom frame 30 in some configurations.

The cushion 42 is disposed on the seat back frame 40. The cushion 42 is made of a compliant material that supports the seat occupant and distributes load forces from the seat occupant to the seat back frame 40. It is contemplated that the cushion 42 may be integrally formed with the cushion 32 of the seat bottom 20 or separate from the cushion 32 of the seat bottom 20. The cushion 42 and associated methods of manufacture will be discussed in more detail below.

The trim cover 44 covers at least a portion of the cushion 42. In addition, the trim cover 44 provides one or more visible exterior surfaces of the seat back 22. The seat occupant may be disposed on the trim cover 44 when seated upon the seat assembly 10. The trim cover 44 is made of any suitable material or materials, such as fabric, leather, leatherette, vinyl, or combinations thereof. The trim cover 44 may include one trim panel or a plurality of trim panels that are assembled in any suitable manner, such as by fusing or stitching. The trim cover 44 is attached to the seat back frame 40, the cushion 42, or both. For example, the trim cover 44 may include trim attachment features that are attached to the seat back frame 40, the cushion 42, or both, to inhibit removal of the trim cover 44 and help conform the trim cover 44 to the contour of the seat back frame 40, the cushion 42, or both. It is contemplated that different types of trim attachment features may be employed to attach the trim cover 44 to the seat back frame 40 than to the cushion 42. The trim cover 44 may also be attached to an attachment pad.

The head restraint 46, if provided, is configured to support the head of a seat occupant. The head restraint 46 is disposed at the top of the seat back 22 or at an end of the seat back 22 that is disposed opposite the seat bottom 20. The head restraint 46 may be moveable in one or more directions with respect to the seat back 22 or may be integrally formed with the seat back 22.

Referring to FIG. 2, an example of a cushion 50 is shown. The cushion is generically designated with reference number 50 for convenience in reference. It is to be understood that the structure and description of the cushion 50 is applicable to the cushion 32 of the seat bottom 20, the cushion 42 of the seat back 22, or both.

The cushion 50 is a non-foam component or includes at least one non-foam component. The non-foam component is primarily referred to as a mesh member but may also be referred to as a stranded member, looped member, entangled member, filament mesh structure, mesh structure, stranded mesh, looped mesh, entangled mesh, or mesh cushion. In FIG. 2, the cushion 50 is simplified and depicted as a non-foam component that does not include a foam component or foam material, such as urethane or polyurethane foam; however, it is contemplated that the cushion 50 may also include a foam component or foam material in addition to a non-foam component to provide additional cushioning or localized cushioning for a seat occupant. For example, foam material may be provided between the cushion 50 and a trim cover (e.g., trim cover 34, 44) that is disposed on the cushion 50, within the cushion 50, or combinations thereof. Reducing the amount of foam material that is provided with the cushion 50 or eliminating foam material from the cushion 50 reduces weight and may improve support and comfort of a seat occupant. In addition, eliminating foam material may facilitate recycling of the cushion 50.

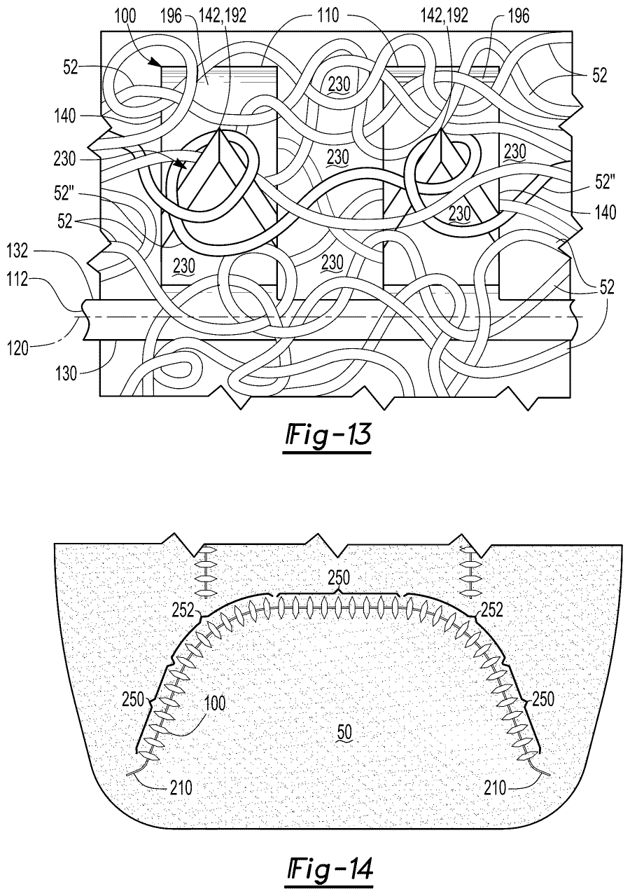

The cushion 50 is primarily described below in the context of a cushion 50 that does not include foam material. In this context, the cushion 50 is made of filaments 52 of polymeric material that are randomly looped, bent, curled, or entangled and are bonded together as will be discussed in more detail below. Examples of filaments 52 is shown in FIGS. 11 and 13. A filament 52 is directly bonded to another filament 52 rather than being indirectly bonded with a resin or other intermediate material.

The filaments 52, which may also be referred to as strands or threads, are made of any suitable material or materials. In some configurations, the filaments 52 are made of a polymeric material or thermoplastic material, such as a thermoplastic resin that is polyamide-based, polyester-based, polyimide-based, polyolefin-based (e.g., polypropylene-based, polyethylene-based, etc.), polystyrene-based, or combinations thereof. As one example, a polyethylene-based filament may be made of linear low density polyethylene (LLPDE). The filament material may be recyclable unlike foam material or more easily recycled than foam material. It is also contemplated that a filament 52 may comprise reinforcement fibers and that the reinforcement fibers may not be made of a thermoplastic material.

In some configurations, a filament 52 may be a monofilament that is made of a single material. In some configurations, a filament 52 is made of multiple materials. As an example, a filament 52 made of multiple materials may include a core that is made of a first thermoplastic material and a sheath that encircles the core and is made of a second thermoplastic material that differs from the first thermoplastic material. It is contemplated that the cushion 50 may include a combination of monofilaments and filaments that are made of multiple materials and are not monofilaments.

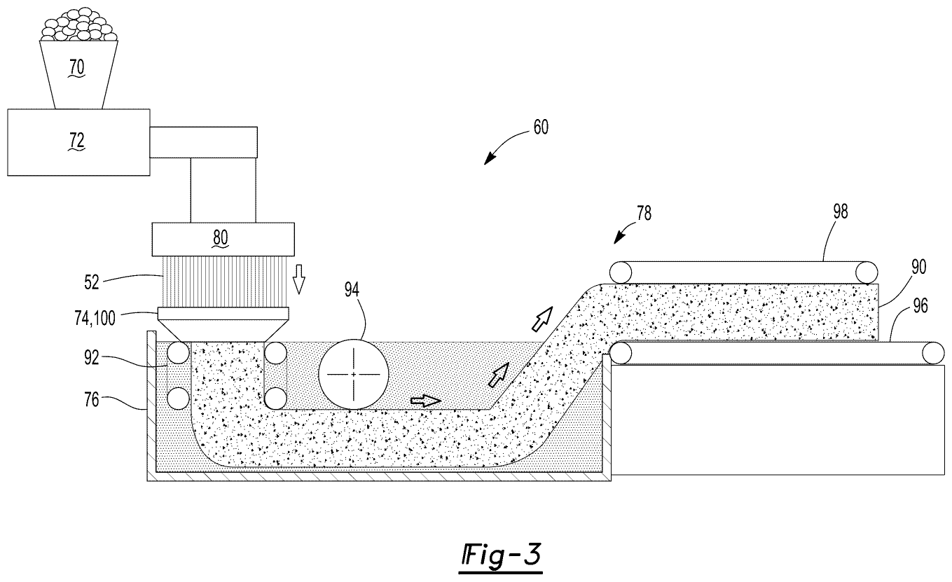

Filaments 52 that are randomly looped, bent, looped, curled, or entangled are bonded together where one filament 52 contacts another filament 52, thereby resulting in a lightweight, air permeable cushion (e.g., cushion 32 and/or 42) or mesh structure having openings or voids between the filaments 52. An example of a manufacturing system 60 of making a cushion or mesh member is also shown in FIG. 3. In this example, the manufacturing system 60 includes a material supply 70, an extruder 72, and a funnel 74. The manufacturing system 60 also includes a cooling tank 76 and a material handling subsystem 78.

Referring to FIG. 3, the material supply 70 holds material stock that is to be extruded, such as solid beads, flakes, granules, pellets, or powder made of the material. In some configurations, the material supply 70 is configured as a container or hopper. The material supply 70 provides material stock to the extruder 72.

The extruder 72 melts the material stock and extrudes the material stock into a set of filaments 52. The extruder 72 may have any suitable configuration. In some configurations, the extruder 72 includes a barrel that receives a rotatable screw and heating elements. Rotation of the screw forces the material to move through the barrel and helps heat the material due to the friction generated as the screw rotates. The material exits the barrel under pressure and in a molten state and is transported to a die 80 of the extruder 72.

The die 80, which may also be referred to as a die plate or extrusion die, has multiple through holes or filament forming openings through which the molten material passes. A single filament 52 is extruded from each through hole. The filaments 52 fall downward from the die 80 under the force of gravity into the funnel 74.

The funnel 74 consolidates or groups the filaments 52 into a more compact arrangement in which the filaments bend, curl, or loop and a filament 52 contacts and bonds to at least one other filament 52. The funnel 74 has a funnel inlet and a funnel outlet that is smaller than the funnel inlet. Individual separated filaments 52 enter the funnel inlet. The filaments 52 bend, curl, or loop and move into contact as they accumulate. The filaments 52 slide down the funnel 74 toward the funnel outlet. Each member of the set of filaments 52 may be bonded to at least one other member of the set of filaments 52. Bonds are formed between filaments 52 at the points of contact while openings or voids between filaments 52 are present at other locations where one filament 52 does not contact or bond to another filament 52. The entangled and bonded filaments 52 pass through the funnel outlet of the funnel 74 and enter the cooling tank 76. For convenience in reference, the bonded filaments 52 are referred to as a filament mesh structure or mesh member 90.

The cooling tank 76 holds a liquid, such as water or a mixture of water and another fluid. The liquid in the cooling tank 76 helps support the entangled and bonded filaments 52 to limit further compacting or consolidation of the filaments 52 into a less open or less porous arrangement and maintains a desired porosity and density of the mesh member 90. Thus, the liquid provides some buoyancy or resistance that can result in additional bending, curling, or looping of the filaments 52 adjacent to the surface of the liquid or within the funnel 74 to further build the mesh member 90. The liquid also cools the filaments 52 when the filaments 52 are in the liquid. For instance, the liquid cools the filaments 52 from the outside to solidify the filaments 52 and prevent the filaments 52 from bonding at additional locations. At this point, the filaments 52 are relatively stiff and no longer in a plastic state and thus generally maintain a shape and are not moldable or reformable without being reheated.

The material handling subsystem 78 transports the mesh member 90 through the cooling tank 76. The material handling subsystem 78 includes various rollers and conveyors that help move the mesh member 90 through the liquid and out of the liquid. In some configurations, a tractor conveyor 92 is provided in the cooling tank 76 to help pull the mesh member 90 away from the funnel 74 and to counter buoyancy of the filaments 52.

One or more other rollers, such as roller 94, keep the mesh member 90 submerged in the liquid and guide the mesh member 90 through the cooling tank 76. For example, the roller 94 may guide the mesh member 90 toward a conveyor belt 96 and shaker table 98 that are disposed outside of the cooling tank 76. The shaker table 98 shakes the mesh member 90 while it is on the conveyor belt 96 to remove liquid. Alternatively or in addition, the mesh member 90 may be squeezed to remove liquid, air may be blown toward the mesh member 90 to remove liquid from the mesh member 90, or both. It is also contemplated that the mesh member 90 may also be allowed to drip dry, or dry in ambient air.

The manufacturing system 60 described above is a continuous flow process in which the mesh member 90 is formed as a continuous structure when filament extrusion is not interrupted. Further processing of the mesh member 90 is provided after exiting the cooling tank 76 to cut the mesh member 90 into individual pieces or blanks for individual cushions. Such processing is conducted by a cutting subsystem of the manufacturing system 60. The cutting subsystem may be of any suitable type. For instance, the cutting subsystem may employ a blade, knife, hot knife, saw, fluid jet, or the like to cut the filaments 52 of the mesh member 90 into a blank. As an example, the cutting subsystem may cut a slit in the mesh member 90 that receives a clip. It is also contemplated that a blank may be further shaped or contoured with other manufacturing processes, such as molding of the entire blank or a portion thereof.

With the above process, the cushion 50 may be formed of a set of filaments 52, wherein at least two members of the set of filaments 52 are looped and bonded to each other. In one or more embodiments, each member of the set of filaments 52 is looped and bonded to at least one other member of the set of filaments.

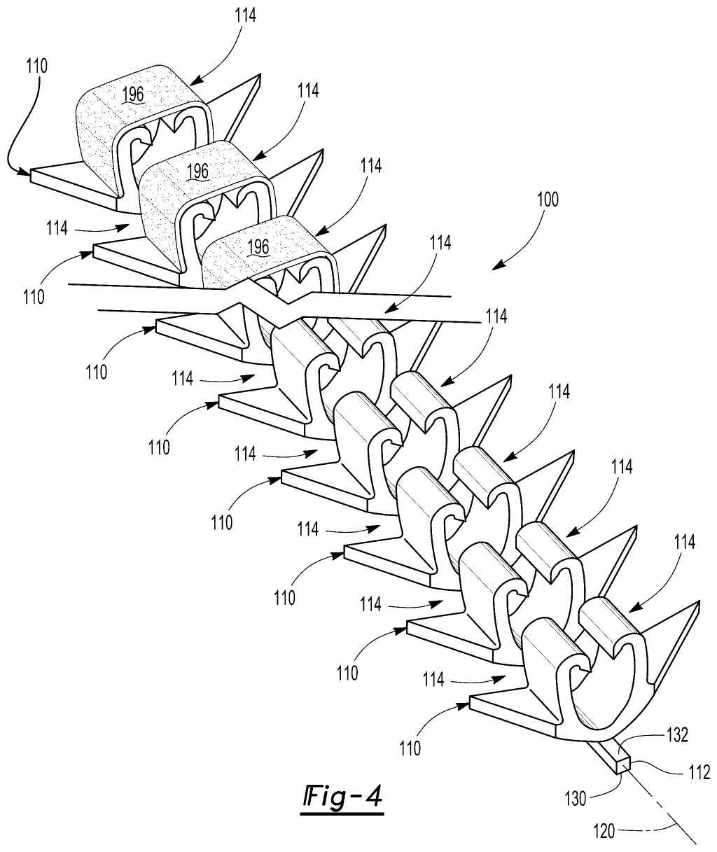

Referring to FIG. 4, an example of a clip 100 is shown. In FIG. 4, the clip 100 is shown with a trim cover attachment feature above the break line and with the trim cover attachment feature omitted below the break line. The trim cover attachment feature may be configured as a hook and loop fastener as will be discussed in more detail below. In FIG. 4, a first strip 196 of a hook and loop fastener is shown on the three clip segments disposed above the break line and is omitted on the other clip segments for clarity.

The clip 100 is configured to secure a trim cover to a cushion, such as a cushion 50 that includes the mesh member 90; however, it is also contemplated that the clip 100 may also be provided with a cushion that includes or is made of foam. An example of the clip 100 of FIG. 4 securing a trim cover to a mesh member 90 is shown in FIG. 12. The trim cover is generically designated with reference number 102 for convenience in reference. The trim cover 102 may be the trim cover 34 of the seat bottom 20 or the trim cover 44 of the seat back 22.

The clip 100 is made of any suitable material or materials. In some configurations, the clip 100 is made of a polymeric material. The clip 100 may be made of the same material as the filaments 52 or a material that differs from the filaments 52. The polymeric material may be recyclable.

The clip 100 is manufactured using any suitable process. As some examples, the clip 100 may be molded, extruded, or made with an additive manufacturing process, such as 3D printing. It is contemplated that the clip 100 is manufactured as a unitary one-piece component that may be cut to a suitable length that is installed in the mesh member 90.

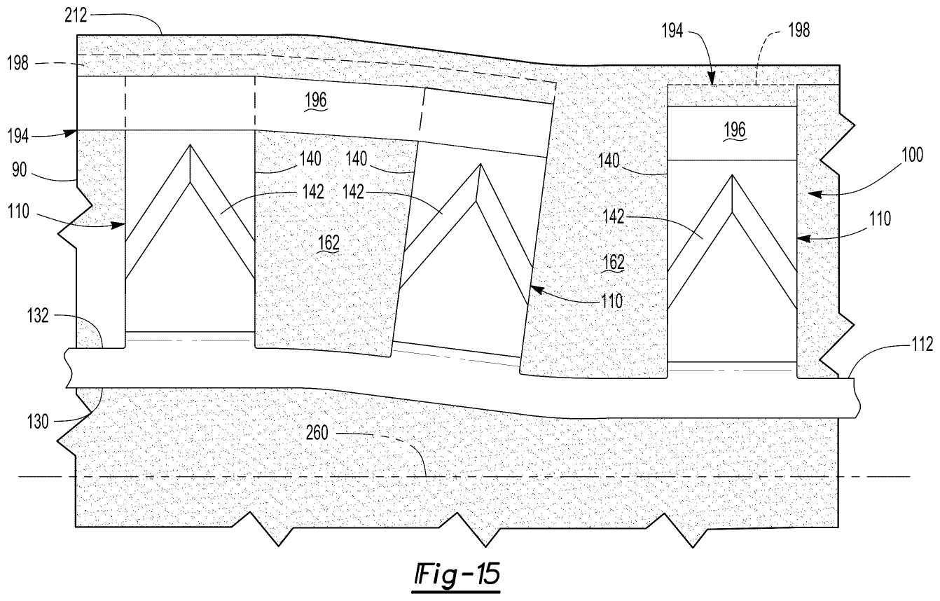

Referring primarily to FIGS. 4 and 15, the clip 100 includes one or more of clip segments 110. In a configuration having multiple clip segments 110, a spine 112 is provided with the clip 100. In such a configuration, the spine 112 interconnects the clip segments 110. The clip segments 110 are spaced apart from each other such that a gap 114 is provided between one clip segment 110 and an adjacent clip segment 110. The clip 100 will primarily be described in the context of a clip 100 having multiple clip segments 110.

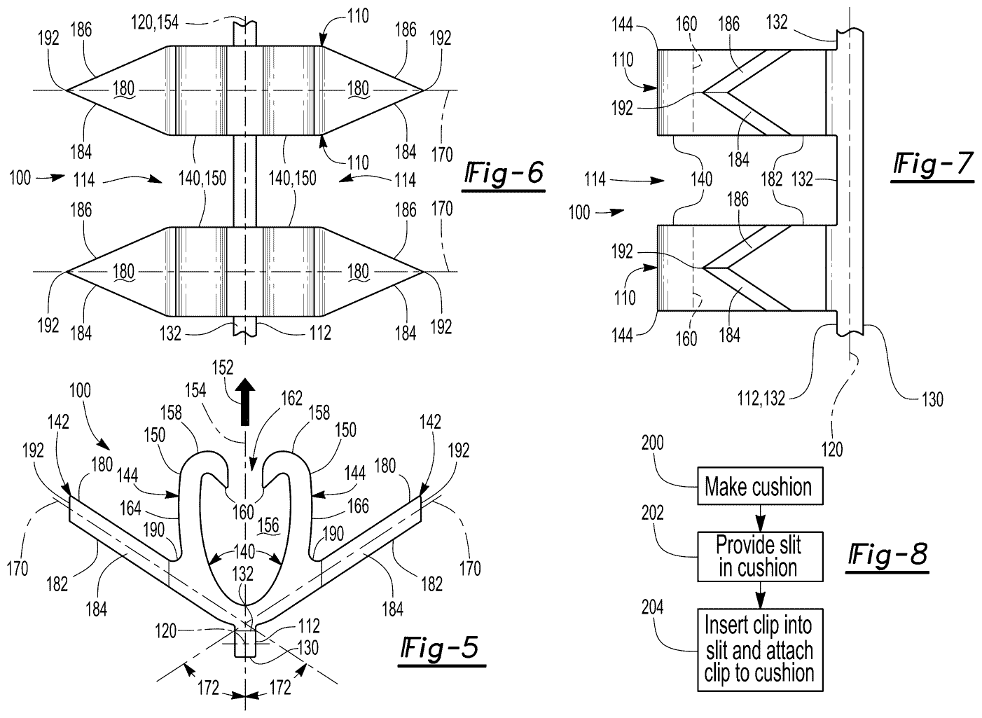

Referring to FIGS. 4-5, an example of a spine 112 is shown. In some configurations, the spine 112 is flexible and allows the clip segments 110 to be positioned at various orientations with respect to each other as will be discussed in more detail below. The spine 112 may be configured as a column, shaft, rod, elongated member, or the like. In some configurations, the spine 112 is linear or extend along a linear spine axis 120 when the spine 112 is in a free state such as is shown in FIG. 4. The spine 112 includes a bottom side 130 and a top side 132.

The bottom side 130 faces away from the clip segments 110. In some configurations, the bottom side 130 extends the length of the clip 100.

The top side 132 is disposed opposite the bottom side 130. As such, the top side 132 may face toward the clip segments 110. In some configurations, the top side 132 is segmented and extends from one clip segment 110 to an adjacent clip segment 110 or is visible between adjacent clip segments 110, 110.

In the configuration shown in FIGS. 4 and 5, the spine 112 is positioned below the clip segments 110. It is also contemplated that the spine 112 may be positioned at a higher elevation than is shown in these figures. For instance, the spine 112 may extend from a side of a first clip segment 110 that faces toward an adjacent second clip segment 110 to a corresponding side of the adjacent clip segment 110 that faces toward the first clip segment 110 rather than being disposed below one or more clip segments 110. As an example, the spine 112 may be moved up from the position shown in FIG. 5 such that the top side 132 in FIG. 5 becomes the bottom side 130 and the top side 132 is hidden behind the clip segment 110 from the perspective shown.

Referring primarily to FIG. 5, a clip segment 110 includes a mount 140 and at least one barb 142. The mount 140 can be provided in various configurations. The configuration shown in FIG. 5 will be described first.

The mount 140 (e.g., support, base, protrusion, pedestal, pillar, stand) extends from the spine 112. In some configurations, the mount 140 extends away from the bottom side 130 of the spine 112. For instance, the mount 140 may extend from the top side 132 of the spine 112. The mount 140 may protrude from the spine 112 to help position a trim cover attachment feature configured as a hook and loop fastener closer to the trim cover 102, which may make it easier to couple the trim cover 102 to the clip 100 with the hook and loop fastener.

In the configuration shown in FIG. 5, the mount 140 includes a first retention feature 144 and a second retention feature 144. For convenience in reference, the first retention feature 144 may be disposed to the left in FIG. 5 and the second retention feature 144 may be disposed to the right.

The first retention feature 144 and the second retention feature 144 each have an arm 150 that extends away from the spine 112. For instance, an arm 150 may extend away from the bottom side 130 of the spine 112 or extend away from the spine 112 in a first direction 152 along or with respect to a center plane 154 of the clip segment 110. The center plane 154 may bisect the clip segment 110. In the configuration shown, the center plane 154 is disposed between the first and second retention features 144, 144 or at a location where the first retention feature 144 meets the second retention feature 144. The first direction 152 extends away from the spine 112 or in an upward direction from the perspective shown in FIG. 5. The center plane 154 may extend through the spine 112. the center plane 154 may or may not bisect the spine 112. In some configurations, the spine axis 120 is disposed in center plane 154 of a clip segment 110, such as when the clip 100 is in a free state.

The arm 150 of the first retention feature 144 is spaced apart from the arm 150 of the second retention feature 144. As such, the arms 150, 150 cooperate to at least partially define a cavity 156 therebetween.

A top side 158 of the mount 140 faces away from the spine 112. For example, the top side 158 of the mount may face away from the bottom side 130 of the spine 112. In the configuration in FIG. 5, the top side 158 may be disposed proximate the hook 160.

In some configurations, an arm 150 includes a hook 160 that is provided at a distal end of an arm 150. The hook 160 of the arm 150 of the first retention feature 144 may extend toward the hook 160 of the arm 150 of the second retention feature 144. The first retention feature 144 and the second retention feature 144 may cooperate to define a gap 162. The gap 162 (e.g., opening, open space, slot, aperture, orifice, etc.) may be provided between the hooks 160, 160 and may be narrower than an adjacent portion of the cavity 156. The hooks 160, 160 may help facilitate installation of the clip 100 into the mesh member 90 as will be discussed in more detail below.

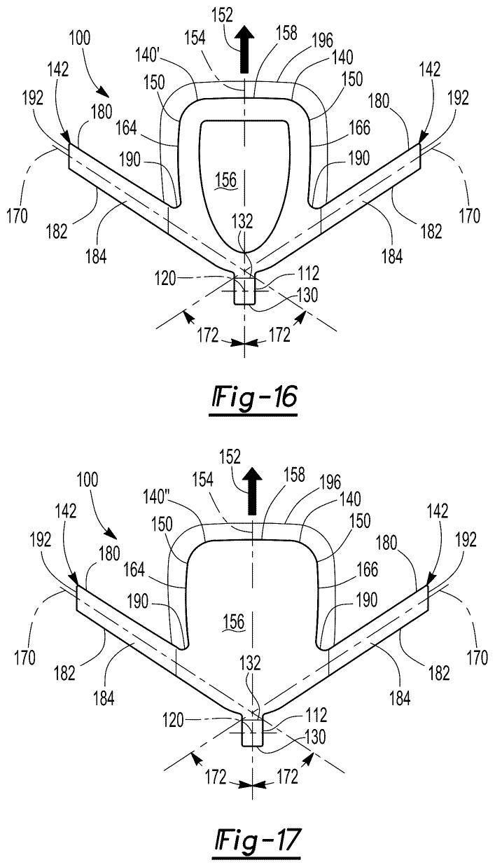

Examples of some other configurations of mounts 140 are shown in FIGS. 16 and 17.

In the configuration shown in FIG. 16, the gap 162 is omitted from the mount 140′. The arms 150, 150 do not have hooks at their respective distal ends. Instead, the arms 150, 150 meet and enclose or encircle the cavity 156 when viewed from the side or along the length of the spine 112 as shown. As such, the cavity 156 is disposed above the spine 112 and below a bridge or segment above the cavity 156 where the arms 150, 150 meet. The top side 158 of the mount 140′ faces away from the spine 112. For instance, the top side 158 may extend over the cavity 156. Providing a top side 158 that extends over the cavity 156 or from one arm to another may provide more surface area for mounting a hook and loop fastener as compared with other configurations, such as when a gap 162 is provided. The hook and loop fastener will be discussed in more detail below.

In the configuration shown in FIG. 17, the cavity 156 and gap 162 are both omitted for the mount 140″. In such a configuration, the mount 140″ may have a generally solid configuration. The top side 158 of the mount 140″ again faces away from the spine 112. Such a configuration may provide a mount 140″ that is less susceptible to bending or flexing, which may help better maintain the shape of the mount 140″ and may reduce flexing of a hook and loop fastener disposed thereon.

Referring to FIGS. 5, 16, and 17, the mount 140 may also include a first mount side 164 and a second mount side 166. The first mount side 164 may be disposed opposite the second mount side 166. The first and second mount sides 164, 166 may face away from the center plane 154 and the cavity 156, if provided. For instance, the first mount side 164 may face toward a first barb 142 and the second mount side 164 may face toward a second barb 142. The first and second mount sides 164, 166 may extend from the top side 158 to or toward a corresponding barb 142.

Referring to FIG. 5, FIG. 16, or FIG. 17, one or more barbs 142 are provided with a clip segment 110. A barb 142 extends from the mount 140, 140′, 140″, the spine 112, or both. In FIG. 5, two barbs 142, 142 are shown, with a first barb 142 and a second barb 142 extending from opposite sides of the mount 140, 140′, 140″. For instance, first barb 142 may extend from the first retention feature 144 and a second barb 142 may extend from the second retention feature 144 such as in the configurations in FIGS. 5 and 16. In some configurations, the barbs 142 are spaced apart from and do not extend from the spine 112.

A barb 142 may extend from the mount 140, 140′, 140″ in a direction that extends away from the center plane 154 and the cavity 156. Similarly, a barb 142 that extends from the spine 112 may also extend in a direction that extends away from the center plane 154, the cavity 156, or both. A barb 142 is configured to secure the clip 100 or an associated clip segment 110 to the cushion 42, such as by grasping, engaging, tethering, attaching, or hooking onto one or more filaments 52 of the mesh member 90 of the cushion 42. Providing a plurality of barbs 142, such as barbs that are disposed on opposite sides of the mount 140, 140′, 140″ or that extend in different directions, may help better resist removal of the clip 100 from the cushion 50.

In some configurations, a barb 142 is disposed in a nonparallel and non-perpendicular relationship with the center plane 154. Moreover, a barb 142 may be oriented to extend away from the bottom side 130 of the spine 112, or in an upward direction from the perspective shown in FIG. 5. Thus, a barb 142 extends in the first direction 152 as the distance from the spine 112 increases. As such, a barb 142 may extend further away from the bottom side 130 as the barb 142 extends away from the spine 112 and the center plane 154. In the configuration shown, the first barb 142 extends away from the second barb 142. As such, the first barb 142 and the second barb 142 may extend in opposite directions with respect to each other or with respect to the center plane 154.

A barb 142 may extend away from the bottom side 130 in a linear or nonlinear manner. In FIGS. 5, 16, and 17, each barb 142 is illustrated as extending along a corresponding barb axis 170. The barb axis 170 may intersect the center plane 154 at an acute angle 172 and may be disposed substantially perpendicular to the center plane 154 when viewed from above or in a plan view as is shown in FIG. 6. The term “substantially perpendicular” is used herein to designate features or axes that are the same as or very close to perpendicular and includes features that are within ±3° of being perpendicular each other. In some configurations, the barb axis 170 intersects the center plane 154 at a location that does not intersect the spine 112, such as at a location where the first retention feature 144 meets the second retention feature 144.

It is also contemplated that a barb 142 may be curved or extend in a nonlinear manner. For instance, a barb 142 or a portion thereof may extend along an arc or curve that may curve upward from the perspective shown or be convex with respect to the spine 112. Providing a barb 142 that extends upward or away from the spine 112 may help make it easier to insert the clip 100 into the cushion 50 and may help improve retention or resist removal of the clip 100 from the cushion 50.

In some configurations, the barb 142 includes an upper side 180, a lower side 182, a first lateral side 184, and a second lateral side 186.

The upper side 180 faces away from the spine 112. In some configurations, the upper side 180 extends from a corresponding retention feature 144. For instance, the upper side 180 may intersect or extend from an arm 150 of a corresponding retention feature 144. The upper side 180 extends further away from the spine 112 as the upper side 180 extends away from a corresponding retention feature 144. The upper side 180 may have a planar or a nonplanar configuration.

The lower side 182 is disposed opposite the upper side 180. As such, the lower side 182 may face toward the spine 112. In some configurations, the lower side 182 extends from a corresponding retention feature 144. In some configurations, the lower side 182 intersects or extends from the spine 112. The lower side 182 may have a planar or nonplanar configuration. The lower side 182 extends further away from the spine 112 as the lower side 182 extends away from a corresponding retention feature 144. In some configurations, the lower side 182 has a greater length than the upper side 180.

In some configurations, the lower side 182 is disposed substantially parallel to the upper side 180. The term “substantially parallel” as used herein means the same as or very close to parallel and includes features or axes that are within ±3° of being parallel each other. The lower side 182 may not intersect the upper side 180 when the lower side 182 is disposed substantially parallel to the upper side 180. In some configurations, the lower side 182 and the upper side 180 are disposed in a nonparallel relationship. For instance, the lower side 182 and the upper side 180 may become closer together as the distance from the center plane 154 increases. It is contemplated in some configurations that the lower side 182 may intersect the upper side 180, such as at a distal end of the barb 142.

Referring primarily to FIGS. 5-7, the first lateral side 184 may extend from the mount 140, 140′, 140″. In some configurations, the first lateral side 184 may extends from a corresponding retention feature 144. For example, as is best shown in FIG. 5, the first lateral side 184 may extend from a protrusion 190 of a corresponding retention feature 144 and may be spaced apart from the arm 150 of the retention feature 144. It is also contemplated that the first lateral side 184 or a portion thereof may extend from the arm 150, if provided. The first lateral side 184 extends from the upper side 180 to the lower side 182. As is best shown in FIG. 6, the first lateral side 184 extends toward the second lateral side 186 as the distance from the center plane 154 increases. For instance, the first lateral side 184 may become closer together as the first lateral side 184 and the second lateral side 186 extend away from the mount 140, 140′, 140″, which may allow a barb 142 to better penetrate and capture filaments 52 of the cushion 50. The first lateral side 184 and the second lateral side 186 may extend toward or become closer to a corresponding barb axis 170 as the distance from the center plane 154 increases. It is contemplated that the first lateral side 184 may be planar or nonplanar.

The second lateral side 186 may be is disposed opposite the first lateral side 184. The second lateral side 186 may also extend from the mount 140, 140′, 140″. In some configurations, the second lateral side 186 extends from a corresponding retention feature 144. In some configurations, the second lateral side 186 may extend from a protrusion 190 of a corresponding retention feature 144 and may be spaced apart from the arm 150 of the retention feature 144. It is also contemplated that the second lateral side 186 or a portion thereof may extend from the arm 150, if provided. The second lateral side 186 extends from the upper side 180 to the lower side 182. The second lateral side 186 extends toward the second lateral side 186 as the distance from the center plane 154 increases. For instance, the second lateral side 186 may extend toward or become closer to a corresponding barb axis 170 as the distance from the center plane 154 increases. Such a configuration may facilitate installation of the clip 100 into the cushion 50 as will be discussed in more detail below. It is contemplated that the second lateral side 186 may be planar or nonplanar.

In some configurations, the first lateral side 184 intersects the second lateral side 186 at a distal end 192 of the barb 142. This may result in a barb 142 having a triangular configuration when viewed from above when the first lateral side 184 and the second lateral side 186 have planar configurations that are oriented vertically as is best shown in FIG. 6. It is also contemplated that the distal end 192 may be rounded or provided with a radius rather than meeting along a linear edge.

Referring primarily to FIG. 12, an example of a trim cover attachment feature configured as a hook and loop fastener 194 is shown. The hook and loop fastener 194, which may also be called Velcro® or a hook and pile fastener, is associated with the clip 100. In some configurations, the hook and loop fastener 194 includes a first strip 196 and a second strip 198. For convenience in reference, the first strip 196 may be the portion the hook and loop fastener 194 that is disposed on or extends from the clip 100 while the second strip 198 may be the portion of the hook and loop fastener 194 that is disposed on or extends from the trim cover 102.

In some configurations, the first strip 196 may be a hook strip or a loop strip. A hook strip is a segment or strip having hooks. For instance, the hook strip may include hooks that extend from a substrate or panel like a tape or ribbon. A loop strip is a segment or strip having loops, piles, or features to which the hooks can grasp, hook onto, or be coupled to. For instance, the loop strips may include loops or piles that extend from a substrate or panel like a tape or ribbon.

Referring to FIGS. 12, 16 and 17, the first strip 196 extends from the mount 140, 140′, 140″. For instance, the first strip 196 of the hook and loop fastener 194 may extend from the top side 158 of the mount 140, 140′, 140″. Such positioning allows the first strip 196 to face toward the trim cover 102 and the location of the second strip 198. The first strip 196 may also extend along one or more additional sides of the mount 140, 140′, 140″. For example, the first strip 196 may extends along the first mount side 164, the second mount side 166, or both. Providing the first strip 196 along one or more additional mount sides of the mount 140, 140′, 140″ may provide more surface area for attaching the strip to the mount 140, 140′, 140″, which may better secure the first strip 196 to the mount 140. Alternatively or in addition, providing the first strip 196 along one or more additional mount sides of the mount 140, 140′, 140″ may provide more surface area for attaching the second strip 198 to the first strip 196, which may better secure the first strip 196 to the second strip 198 or allow the second strip 198 to attach to the first strip 196 at more positions or different positions.

The first strip 196 may be secured to the mount 140, 140′, 140″ in any suitable manner, such as with an adhesive, fastener, weld (e.g., ultrasonic weld), or combinations thereof. It is contemplated that the first strip 196 may be secured to the mount 140, 140′, 140″ during manufacture of the clip 100, such as during extrusion, molding, or molding of the clip 100, or after the clip 100 is manufactured.

In the configuration shown in FIG. 12, the first strip 196 extends from the first and second retention features 144, 144. As such, the first strip 196 extends across the gap 162. This may help reduce the amount of material in the clip 100. Moreover, this may allow the clip 100 to function as a female interface for securing a trim cover when the hook and loop fastener 194 is omitted.

The second strip 198 may also be a hook strip or a loop strip. For example, the second strip 198 may be a loop strip when the first strip 196 is a hook strip. As another example, the second strip 198 may be a hook strip when the first strip 196 is a loop strip.

The second strip 198 may extend from a side of the trim cover 102 that faces toward the clip 100, such as a back side that faces toward the cushion 50. The second strip 198 may be secured to the trim cover 102 in any suitable manner, such as with an adhesive, fastener, stitching, weld (e.g., ultrasonic weld), or combinations thereof.

The hook and loop fastener 194 is configured to secure (e.g., couple, connect, join, tether, attach, fasten, affix, link, etc.) the trim cover 102 to the clip 100 when the clip 100 is installed in the cushion 50, the first strip 196 is secured to the clip 100, the second strip 198 is secured to the trim cover 102, and the first strip 196 and the second strip 198 are in contact and secured to each other.

Referring to FIG. 15, examples of different hook and loop fasteners 194 are shown. In FIG. 15, the second strip 198 is shown in phantom and the trim cover 102 is omitted for clarity. In some configurations, the hook and loop fastener 194 extends from one clip segment 110 to at least one other clip segment 110. An example of this is shown with the left and center clip segments illustrated in FIG. 15. For instance, the first strip 196, the second strip 198, or both may extend from one clip segment 110 to a nearby or adjacent clip segment 110. Such a configuration may increase the surface area along which the first strip 196 and second strip 198 may engage and increase the retention force therebetween. It is contemplated that the hook and loop fastener 194 can extend from more than two clip segments 110.

In some configurations, the hook and loop fastener 194 is disposed on individual clip segments 110 such that the hook and loop fastener 194 does not extend from one clip segment 110 to another. An example of this is shown with the right clip segment 110 illustrated in FIG. 15. In this example, the hook and loop fastener 194 associated with the center clip segment 110 does not extend to the hook and loop fastener 194 disposed on the rightmost clip segment 110. Such a configuration may reduce the overall amount or total length of the hook and loop fastener 194 that is provided with the clip 100.

It is contemplated that the first strip 196 may extend from one clip segment 110 to another clip segment 110 but the second strips 198 on the trim cover 102 may be discontinuous (e.g., may be separated from each other), that the first strip 196 may not extend from one clip segment 110 to another clip segment 110 but the second strip 198 may be continuous and extend from one clip segment 110 to another clip segment 110, or combinations thereof. It is also contemplated that one or more hook and loop fasteners 194 may be provided with a combination of continuous and discontinuous first strips 196, a combination of continuous and discontinuous second strips 198, or both.

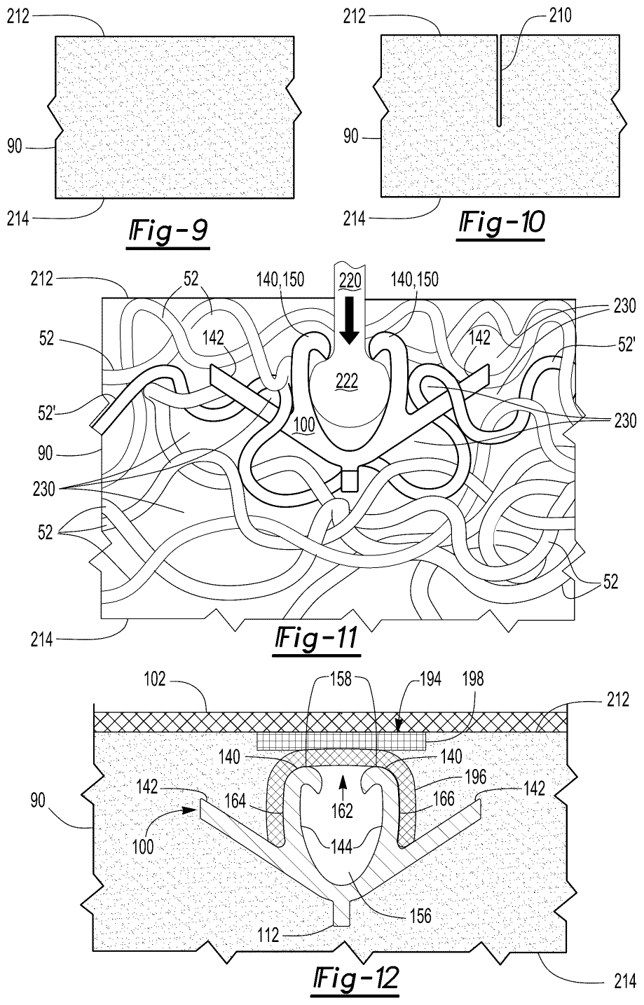

Referring to FIG. 8, a flowchart is shown of a method of manufacture and installation of the clip 100 into a cushion 50 is shown. The cushion is primarily described in the context of the cushion being a mesh member 90 and the clip being the clip shown in FIG. 5. FIGS. 9-12 provide examples associated with the method steps.

At block 200, the mesh member 90 is manufactured. The mesh member 90 may be manufactured using the manufacturing system 60 as previously discussed. An example of a portion of the mesh member 90 is shown in FIG. 9. FIG. 9 is a simplified representation of the mesh member 90 that does not show individual filaments 52 for simplicity.

At block 202, a slit 210 is provided in the mesh member 90. In some configurations, the slit 210 (e.g., trench, groove, channel, cut, etc.) is provided by the cutting subsystem of the manufacturing system 60 as previously described. As such, the slit 210 may be provided by cutting through some filaments 52 of the mesh member 90. An example of a slit 210 is shown in FIG. 10. The slit 210 extends from a first side 212 of the mesh member 90 toward a second side 214 of the mesh member 90 that is disposed opposite the first side 212. The first side 212 may face toward a seat occupant and may engage or contact the trim cover 102 when the trim cover 102 is installed. In some configurations, the slit 210 is a partial cut through the thickness of the mesh member 90 and does not extend to the second side 214.

In some configurations, the slit 210 is provided by forming an indentation in the mesh member 90 without cutting the filaments 52. For instance, the slit 210 may be provided by molding or reshaping the mesh member 90 to provide a slit 210 like a channel or trench that extends from the first side 212. As an example, the mesh member 90 or a region of the mesh member 90 in which the slit 210 is to be provided may be heated with a fluid (e.g., gas, liquid, or both) to soften the mesh member to allow the softened filaments 52 to conform to the shape of a forming surface of a mold or other tool, such as a rod or bar that is engaged against the first side 212. Alternatively, the fluid may be provided under pressure, such as via one or more nozzles, and may both heat the filaments 52 and exert force on the filaments 52 that is sufficient to form the slit 210. The mesh member 90 may be subsequently cooled to stiffen the filaments 52 and set the shape of the mesh member 90 and the slit 210.

At block 204, the clip 100 is inserted into the slit 210 and attached to the mesh member 90.

An example of insertion of the clip 100 is shown in FIG. 11 in which the body of the clip 100 is inserted before the first strip 196 is mounted or attached to the clip 100. A tool 220 having an enlarged tip 222, is inserted through the gap 162 between the first and second retention features 144, 144 of the clip 100 toward the bottom of the cavity 156, the gap 162 being best shown in FIG. 5. Force exerted by the tool 220 causes the arms 150, 150 of the first and second retention features 144, 144 to flex away from each other, thereby permitting the enlarged tip 222 to move past the hooks 160, 160 and into the cavity 156 and temporarily secure the clip 100 to the tool 220.

The tool 220 and the clip 100 are aligned with the slit 210. Relative movement between the tool 220 and the mesh member 90 moves the clip 100 into the slit 210, such as by actuating the tool 220 and the clip 100 toward the slit 210, which is represented by the downward pointing arrowed line in FIG. 11. The force exerted by the tool 220 is sufficient to cause the clip 100 to enter the slit 210, with the spine 112 entering the slit 210 before the arms 150, 150 enter the slit 210. The clip 100 pushes the filaments 52 apart with the barbs 142, 142 acting like a wedge. The filaments 52 may be sufficiently flexible such that insertion of the clip 100 does not cut or sever the filaments 52.

In configurations that employ other clip configurations, such as those shown in FIGS. 16 and 17, the tool 220 may be omitted or have a different configuration. For instance, rather than inserting a tool 220 with an enlarged tip 222 through the gap 162, force may be exerted on the mount 140′, 140′ to push the clip 100 into the mesh member 90. For instance, force may be exerted on the top side 158 of the mount 140′, 140″ that pushes the clip 100 into the mesh member 90. In addition, in such configurations, the first strip 196 may mounted to or attached to the clip 100 before the clip 100 is inserted into the cushion 50.

It is also contemplated, that the clip 100 may be pulled into the mesh member 90 rather than pushing the clip into the mesh member 90 or in addition to pulling the clip 100 into the mesh member 90 in any of the configurations disclosed herein.

The clip 100 may be inserted to a sufficient depth such that the clip 100 is inserted past the first side 212 of the mesh member 90, or such that the clip 100 is spaced apart from and does not extend from the first side 212. Such positioning may help embed the clip 100 at a sufficient depth in the cushion 50 so that the clip 100 is not felt by a seat occupant. As a result, the mount 140, 140′, 140″ is disposed in the slit 210 of the mesh member 90. The first strip 196 may be disposed in the slit 210. In some configurations, the first strip 196 may extend along the mount 140, 140′, 140″ and away from the first side 212 of the mesh member 90 (e.g., downward into the slit 210).

Depending on the configuration of the slit 210, some filaments 52 may extend over the clip 100. For instance, filaments 52 may be disposed between the first side 212 and the mount 140, 140′, 140″. These filaments 52 may help provide cushioning so that the presence of the clip 100 is not perceived by the seat occupant. The clip 100 may be spaced apart from and may not extend to the second side 214 of the cushion 50, which may allow one or more filaments to extend between the spine 112 and the second side 214 and allow the clip 100 to move downward with the cushion 50 when the cushion 50 is compressed so that the clip 100 is not perceived by a seat occupant.

In some configurations, the clip 100 is spaced apart from and does not extend to the second side 214 or rear side of the mesh member 90 when the clip 100 is installed in the mesh member 90. As a result, the clip 100 does not contact the second side 214.

Insertion of the clip 100 causes the barbs 142 to interact with the filaments 52 such that at least some of the filaments 52 contact a barb 142 and the barb 142 becomes ensnared in the filaments 52 such that the clip 100 is retained in the mesh member 90. At least a portion of a barb 142 is received in a void or gap 230 between members of the set of filaments 52. For clarity, only a few gaps 230 are labeled in FIG. 11. At other locations, the barb 142 contacts one or more members of the set of filaments 52.

Due to the looping or curling of the filaments 52, a filament 52 may contact the clip 100 at various locations. In some configurations, at least one member of the set of filaments 52 contacts the first and second barbs 142, 142 of a clip segment 110. An example of this is filament 52′ in FIG. 11. In some configurations, at least one member of the set of filaments 52 contacts at least one retention feature 144 and a barb 142 that extends from the retention feature 144. Filament 52′ also provides an example of this configuration; however, it is to be understood that a filament may contact a retention feature and a corresponding barb with or without contacting another retention feature and/or its corresponding barb.

In some configurations, at least one member of the set of filaments 52 contacts more than one clip segment 110. An example of this is shown in FIG. 13. FIG. 13 shows a side view of a first clip segment 110 and a second clip segment 110 inserted into a slit 210 of the mesh member 90, the slit 210 not being clearly visible from the perspective shown. At least one member of the set of filaments 52, such as filament 52″ contacts the first clip segment 110 and the second clip segment 110. The first clip segment 110 may be the clip segment furthest left and the second clip segment 110 may be furthest right in FIG. 13. Filament 52″ is illustrated as looping or curling around and contacting a barb 142 of the first clip segment 110 and a barb 142 of the second clip segment 110; however, it is to be understood that the filament 52″ need not form a closed loop around or encircle one or both barbs 142. For instance, a filament 52 may extend over a barb 142 and engage the upper side 180, may contact another side of a barb 142, or combinations thereof. A filament that contacts the lower side 182 of a barb 142 may help limit downward movement or tilting of the clip 100. A filament 52 that contacts a lateral side of a barb 142, such as the first lateral side 184 or the second lateral side 186 may prevent or limit movement of the clip 100 in at least one direction along or within the slit 210.

Once the clip 100 is inserted into the mesh member 90, the tool 220 is disengaged from the clip 100 if a tool was used to install the clip 100. For instance, in the configuration shown in FIG. 11, relative movement between the tool 220 and the mesh member 90 in a direction opposite that associated with insertion of the clip 100 into the slit 210 causes the arms 150, 150 of the first and second retention features 144, 144 to flex away from each other, thereby permitting the enlarged tip 222 to move past the hooks 160, 160 and out of the cavity 156, thereby disengaging the clip 100. The first strip 196 may be installed on the clip 100 after the tool 220 is removed.

In configurations in which the tool 220 is not inserted into the cavity 156, the tool 220 can be retracted to disengage the clip 100 without flexing of first and second retention features 144, 144 and the tool 220 moving out of the cavity 156. The clip 100 remain secured in the mesh member 90 due to the resistance or retention force provided by the filaments 52 interacting with the clip 100.

Referring to FIG. 12, a simplified representation of the mesh member 90 that does not show individual filaments 52 is shown for simplicity along with the trim cover 102. In some configurations, the trim cover 102 is installed after the clip 100 is inserted into the slit 210 and secured to the mesh member 90. Installing the trim cover 102 includes engaging the second strip 198 of the hook and loop fastener 194 with the first strip 196 of the hook and loop fastener 194 so that the first strip 196 and second strip 198 contact and attach to each other. For example, the second strip 198 of the hook and loop fastener 194 may be aligned with the first strip 196 on the clip 100 or corresponding clip segment 110 and placed in contact or engagement with each other so that the first strip 196 attaches to the second strip 198. Once attached, the hook and loop fastener resists disengagement, thereby securing the trim cover 102 to the cushion 50 via the clip 100.

Referring to FIG. 14, a portion of a cushion 50 is shown with a clip 100 received in a slit 210. The slit 210 has examples of linear portions 250 and non-linear portions 252. Non-linear portions 252 extend along an arc or curve. The clip 100 follows the path of the slit 210 when the clip 100 is installed due to the flexibility of the spine 112. As such, at least a portion of the spine 112, such as a portion that is received in a non-linear portion 252 of the slit 210, is nonlinear when the clip 100 and its spine 112 are disposed in the mesh member 90.

Referring to FIG. 15, a simplified representation of the mesh member 90 that does not show individual filaments 52 is shown for simplicity along with a portion of the clip 100. The spine 112 is not only flexible along a curved path in a plane but also is flexible out of the plane along a straight or curved path. For example, the spine 112 may extend along an arc such that one or more clip segments 110 are positioned at different elevations in the mesh member 90 with respect to each other. For convenience in reference, the clip segments 110 in FIG. 15 are referred from left to right as a first clip segment, a second clip segment, and a third clip segment.

In this example, the first clip segment 110 (at the left) is disposed at a higher elevation than the second clip segment 110, which may position the first clip segment 110 further from the second side 214 than the second clip segment 110 or further from a horizontal reference plane 260 that extends through the cushion than the second clip segment. The horizontal reference plane 260 is a datum or reference plane that may be disposed at or near the center of the cushion, such as at a midpoint between the first side 212 and the second side 214. The second clip segment is illustrated as being a higher elevation than the third clip segment. In addition, the second clip segment is illustrated as being disposed at an angle with respect to the horizontal reference plane 260 and the first and third clip segments. It is also contemplated that adjacent clip segments 110 may be disposed at different elevations but may be disposed in a common relationship with the horizontal reference plane 260. As such, the present invention allows clip segments 110 to be positioned with respect to each other along curved path, straight paths, in different elevations to follow the contour of the cushion and permit clip segments 110 to be positioned at the same or different depths with respect to the first side 212. This may allow the clip segments 110 to be inserted to sufficient depth in the cushion to help maintain occupant comfort while following the contour of the cushion 50.

Employing the clip as described above with a cushion helps reliably anchor the clip in the cushion, thereby allowing the clip and an associated trim cover to remain in a desired location, which helps keep the trim cover taut and avoids wrinkling or puckering that can provide an undesirable appearance. When employed with a cushion that has a mesh member, the clip can be removed and replaced, thereby facilitating rework and reducing waste. Employing a hook and loop fastener may facilitate securing of a trim cover to a cushion with reduced installation force or effort as compared to inserting a trim cover retention feature into a cavity of the trim clip, which may make is easier to assemble a seat. The clip may replace other configurations that may use more material, such as bands or straps that wrap around and encircle a cushion or paddle fastener configurations in which a strap or trim cover tie-down extends through a slit in the cushion to a paddle or panel that extends along the back side of the cushion.

Clause 1. A clip comprising: a spine; a mount extending from the spine; first and second barbs extending from the mount; and a hook strip or a loop strip of a hook and loop fastener extending from the mount.

Clause 2. The clip of clause 1 wherein the first and second barbs extend from opposite sides of the mount.

Clause 3. The clip of any preceding clause wherein the first and second barbs extend away from a bottom side of the spine.

Clause 4. The clip of any preceding clause wherein the first barb comprises a first lateral side and a second lateral side, wherein the first and second lateral sides are disposed opposite each other and become closer together as the first lateral side and the second lateral side extend away from the mount.

Clause 5. The clip of any preceding clause wherein the mount extends away from a bottom side of the spine.

Clause 6. The clip of clause 5 wherein the hook strip or the loop strip of the hook and loop fastener extends from a top side of the mount that faces away from the bottom side of the spine.

Clause 7. The clip of any preceding clause wherein the hook strip or the loop strip of the hook and loop fastener extends along a first mount side of the mount that faces toward the first barb.

Clause 8. The clip of claim 7 wherein the hook strip or the loop strip of the hook and loop fastener extends along a second mount side of the mount that faces toward the second barb.

Clause 9. The clip of any preceding clause wherein the mount comprises first and second retention features extending away from a bottom side of the spine and cooperating to define a gap.

Clause 10. The clip of clause 9 wherein the hook strip or the loop strip of the hook and loop fastener extends from the first and second retention features.

Clause 11. A seat assembly comprising: a mesh member comprising a first side and a set of filaments of polymeric material, at least two members of the set of filaments are looped and bonded to each other; a trim cover; a clip disposed in the mesh member, the clip comprising: a spine; and a first clip segment comprising: a mount extending from the spine; and first and second barbs securing the first clip segment to the mesh member, wherein the first and second barbs extend away from the spine and toward the first side of the mesh member; and a hook and loop fastener securing the trim cover to the clip.

Clause 12. The seat assembly of clause 11 wherein the hook and loop fastener comprises a hook strip and a loop strip, wherein one of the hook strip and the loop strip is secured to the mount and the other of the hook strip and the loop strip is secured to the trim cover.

Clause 13. The seat assembly of clause 11 or clause 12 wherein the first barb is received in a gap between members of the set of filaments.

Clause 14. The seat assembly of clause 11, clause 12, or clause 13 wherein the mesh member comprises a slit extending from the first side, wherein the clip is disposed in the slit and is spaced apart from and does not extend to the first side.

Clause 15. The seat assembly of clause 14 wherein the mesh member comprises a second side opposite the first side, wherein the slit and the clip are spaced apart from and do not extend to the second side.

Clause 16. The seat assembly of clause 14 or claim 15 wherein the hook and loop fastener extends from a top side of the mount disposed in the slit.

Clause 17. The seat assembly of any of clauses 11 to 16 wherein the hook and loop fastener extends along the mount away from the first side of the mesh member.

Clause 18. The seat assembly of any of clauses 11 to 17 wherein the mount comprises first and second retention features extending away from a bottom side of the spine and the hook and loop fastener extends from the first and second retention features.

Clause 19. The seat assembly of clause 18 wherein the hook and loop fastener extends across a gap between the first and second retention features.

Clause 20. The seat assembly of any of clauses 11 to 19 wherein the clip comprises a second clip segment extending from the spine and separated from the first clip segment, wherein the hook and loop fastener extends from the first clip segment to the second clip segment.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A clip comprising:
a spine;
a mount extending from the spine;
first and second barbs extending from the mount; and
a hook strip or a loop strip of a hook and loop fastener extending from the mount.

2. The clip of claim 1 wherein the first and second barbs extend from opposite sides of the mount.

3. The clip of claim 1 wherein the first and second barbs extend away from a bottom side of the spine.

4. The clip of claim 1 wherein the first barb comprises a first lateral side and a second lateral side, wherein the first and second lateral sides are disposed opposite each other and become closer together as the first lateral side and the second lateral side extend away from the mount.

5. The clip of claim 1 wherein the mount extends away from a bottom side of the spine.

6. The clip of claim 5 wherein the hook strip or the loop strip of the hook and loop fastener extends from a top side of the mount that faces away from the bottom side of the spine.

7. The clip of claim 6 wherein the hook strip or the loop strip of the hook and loop fastener extends along a first mount side of the mount that faces toward the first barb.

8. The clip of claim 6 wherein the hook strip or the loop strip of the hook and loop fastener extends along a second mount side of the mount that faces toward the second barb.

9. The clip of claim 1 wherein the mount comprises first and second retention features extending away from a bottom side of the spine and cooperating to define a gap.

10. The clip of claim 9 wherein the hook strip or the loop strip of the hook and loop fastener extends from the first and second retention features.

11. A seat assembly comprising:
a mesh member comprising a first side and a set of filaments of polymeric material, at least two members of the set of filaments are looped and bonded to each other;
a trim cover;
a clip disposed in the mesh member, the clip comprising:
a spine; and
a first clip segment comprising:
a mount extending from the spine; and
first and second barbs securing the first clip segment to the mesh member, wherein the first and second barbs extend away from the spine and toward the first side of the mesh member; and
a hook and loop fastener securing the trim cover to the clip.

12. The seat assembly of claim 11 wherein the hook and loop fastener comprises a hook strip and a loop strip, wherein one of the hook strip and the loop strip is secured to the mount and the other of the hook strip and the loop strip is secured to the trim cover.

13. The seat assembly of claim 11 wherein the first barb is received in a gap between members of the set of filaments.

14. The seat assembly of claim 11 wherein the mesh member comprises a slit extending from the first side, wherein the clip is disposed in the slit and is spaced apart from and does not extend to the first side.

15. The seat assembly of claim 14 wherein the mesh member comprises a second side opposite the first side, wherein the slit and the clip are spaced apart from and do not extend to the second side.

16. The seat assembly of claim 14 wherein the hook and loop fastener extends from a top side of the mount disposed in the slit.

17. The seat assembly of claim 11 wherein the hook and loop fastener extends along the mount away from the first side of the mesh member.

18. The seat assembly of claim 11 wherein the mount comprises first and second retention features extending away from a bottom side of the spine and the hook and loop fastener extends from the first and second retention features.

19. The seat assembly of claim 18 wherein the hook and loop fastener extends across a gap between the first and second retention features.

20. The seat assembly of claim 11 wherein the clip comprises a second clip segment extending from the spine and separated from the first clip segment, wherein the hook and loop fastener extends from the first clip segment to the second clip segment.
